(19) United States
(12) Patent Application Publication
(10) Pub. No.: US 2011/0066497 A1
(43) Pub. Date: Mar. 17, 2011

(54) PERSONALIZED ADVERTISING AND RECOMMENDATION

(75) Inventors: Dinesh Gopinath, Newton, MA (US); Michael Strickman, Weston, MA (US)

(73) Assignee: ChoiceStream, Inc., Cambridge, MA (US)

(21) Appl. No.: 12/871,416

(22) Filed: Aug. 30, 2010

Related U.S. Application Data
(60) Provisional application No. 61/242,067, filed on Sep. 14, 2009.

(51) Int. Cl. G06Q 30/00

(52) U.S. Cl. 705/14.53

(57) ABSTRACT

Systems and methods for recommending items to users include maintaining a database of user-related information including user profiles, each including at least a history of user activities associated with a first entity that has a relationship with an inventory of recommendable items; obtaining information about an identity of a user interacting with a second entity different from the first entity and different from the service provider; associating the identity of the user interacting with the second entity with a corresponding user profile; selecting a first set of items from the inventory for presentation to the user based at least on an analysis of a history of user activities associated with the first entity; and forming a specification of the selected first set items for presentation to the user during the user's interaction with the second entity.

### CROSS-REFERENCE TO RELATED APPLICATIONS

This application claims the benefit of U.S. Provisional Application No. 61/242,067 filed Sep. 14, 2009, the contents of which are incorporated herein by reference in its entirety. This application is also related to U.S. patent application Ser. No. 12/431,316 (Attorney Docket No. 30003-002003), titled “Statistical Personalized Recommendation System,” filed Apr. 28, 2009, U.S. patent application Ser. No. 11/968,999 (Attorney Docket No. 30003-006001), titled “Music Recommendation Systems,” filed Jan. 3, 2008, U.S. patent application Ser. No. 11/968,945 (Attorney Docket No. 30003-004001), titled “Personalized Shopping Systems,” filed Jan. 3, 2008, and U.S. patent application Ser. No. 11/477,163 (Attorney Docket No. 30003-010001), titled “Methods and Apparatus for a Statistical System for Targeting Advertisements,” filed Jun. 28, 2006. The contents of the above applications are incorporated herein by reference.

### BACKGROUND

This application relates to personalized advertising and recommendation.

With the rapid growth of the amount of content available over the internet, advertising and recommendation systems provide a useful tool to help consumers locate content relevant to their tastes and interests. In addition to improving users' overall shopping experience, an advertising and recommendation system can also provide great benefits to retailers that offer such services. For example, good product recommendations are proven to generate faster sales conversions, increase order size, boost engagement, and improve return on advertising speed. Consumers are also more likely to return to, or shop at, sites that provide high quality recommendations.

### SUMMARY

In general, in one aspect, the invention features a computer-implemented method for recommending items to users that includes: maintaining, by a service provider, a database of user-related information including storing a plurality of user profiles, each user profile including at least a history of user activities associated with a first entity that has a relationship with an inventory of recommendable items, wherein the history of user activities includes data representing events indicative of user's item-specific interest in each of a subset of one or more recommendable items, and the first entity is different from the service provider; obtaining information about an identity of a user interacting with a second entity different from the first entity and different from the service provider; associating the identity of the user interacting with the second entity with a corresponding user profile in the database; selecting a first set of one or more items from the inventory of recommendable items for presentation to the user based at least on an analysis of the history of user activities associated with the first entity, including: selecting at least one item from the subset of recommendable items based on data representing events indicative of user's item-specific interest; and forming a specification of the selected first set of one or more items for presentation to the user during the user's interaction with the second entity.

Embodiments of the invention may include one or more of the following features.

The computer-implemented method selecting at least one item of user interest may include computing, for each item in the subset of recommendable items, a degree of user interest based at least on data representing events indicative of user's item-specific interest.

The computer-implemented method of selecting the set of one or more items may include computing, for each item in the inventory, a degree of user relevance based on the analysis of the history of user activities associated with the first entity. The degree of user relevance may be further computed based on an analysis of a context of the user's interaction with the second entity.

In response to a user reaction to the presentation of the selected first set of one or more items, the computer-implemented method may further include selecting a second set of one or more items from the inventory of recommendable items for subsequent presentation to the user based on at least on the corresponding user profile. The second set of one or more items may be at least partially different from the set of one or more items selected based at least on an analysis of the history of user activities associated with the first entity. The computer-implemented method may further include forming a specification of the second set of one or more items for subsequent presentation to the user. The subsequent presentation of the second set of one or more items may be provided in the form of a dynamic landing page. Upon user selection of an item from the second set of one or more items to the user, the computer-implemented method may further include determining a third set of one or more items to be recommended to the user during a presentation of the selected item to the user. The computer-implemented method may further include forming a specification of the third set of one or more items to be recommended to the user; and providing the formed specification of the third set of one or more items to the first entity. The computer-implemented method may further include updating the corresponding user profile according to user activities associated with the presentations of the first, the second, and the third set of one or more items.

The first entity may have a business relationship with the inventory of recommendable items. The first entity may include a supplier of the inventory of recommendable items. The first entity may have a non-business relationship with the inventory of recommendable items. The events indicative of a user's item-specific interest in a recommendable item may include a user interaction with the item.

The computer-implemented method of obtaining information about an identity of a user interacting with the second entity may include obtaining information about the identity of the user from the second entity.

The first entity may include an advertiser. The first entity may include a plurality of advertisers each having a relationship with a respective inventory of recommendable items, and maintaining the database of user-related information includes updating each user profile according to user activities associated with one or more of the plurality of advertisers.

The second entity may include a publisher. The user's item-specific interest in each of a subset of one or more recommendable items may include the user's explicit interest, implicit interest, or a combination of both.

The computer-implemented method may further include presenting the first set of one or more items to the user during the user's interaction with the second entity.

The specification of the selected first set of one or more items may include data representing an identification of the selected items in the inventory. The specification of the selected first set of one or more items may further include data representing a URL of an image associated with the selected item.

In general, in another aspect, the invention features a system for servicing clients that includes a data manager for managing a database of user-related information, the database including a plurality of user profiles, each user profile including at least a history of user activities associated with one or more of a set of clients each client having a relationship with a corresponding inventory of recommendable items, wherein the history of user activities includes data representing events indicative of user's item-specific interest; and a server for recommending items to users based on the information in the database, the server including: an interface for accepting, from a data network, a service request associated with a client for recommending items to a user of said client, the service request including data representing an identity of the user; a service engine coupled to the interface for selecting a set of one or more items from the inventory of recommendable items corresponding to said client to be recommended to the user, the service engine being configured for: associating the user with a corresponding user profile in the database according to the data representing the identity of the user; selecting the set of one or more items to be recommended to the user based at least on an analysis of data representing events indicative of the user's item-specific interest; forming a specification of the selected set of one or more items for presentation to the user during the user's interaction with the second entity; and instructing the interface to send, via the data network, a response to said client forwarding the specification of the selected set of one or more items.

Embodiments of the invention may include one or more of the following features.

The service request may be initiated by said client. The client may include an advertiser.

The service request may be initiated by an entity hosting an advertising resource designated for the client. The entity hosting the advertising resource may include a publisher.

The database may include public data commonly accessible by each of the set of clients. The database may include a collection of one or more sets of proprietary data each set being accessibly only by a corresponding authorized client.

The service engine may be further configured for selecting the set of one or more items based on the user's history of activities that occurred with a second client different from said client with which the service request is associated.

The data manager may be further configured for updating the plurality of user profiles using data provided by one or more of the clients over the data network.

### BRIEF DESCRIPTION OF DRAWINGS

FIG. 1 is a block diagram of one embodiment of a personalized advertising and recommendation system.

FIG. 2 is a block diagram of one embodiment of the service provider of FIG. 1.

FIGS. 3A-3C illustrate examples of an ad creation process.

FIG. 4 is a flow diagram of one procedure for use with the service provider of FIG. 1.

FIG. 5 is block diagram of another embodiment of the service provider of FIG. 1.

FIG. 6 is a block diagram of a further embodiment of the service provider of FIG. 1.

FIG. 7 shows examples of performance reports generated by the service provider of FIG. 1.

### DETAILED DESCRIPTION

### 1 Overview

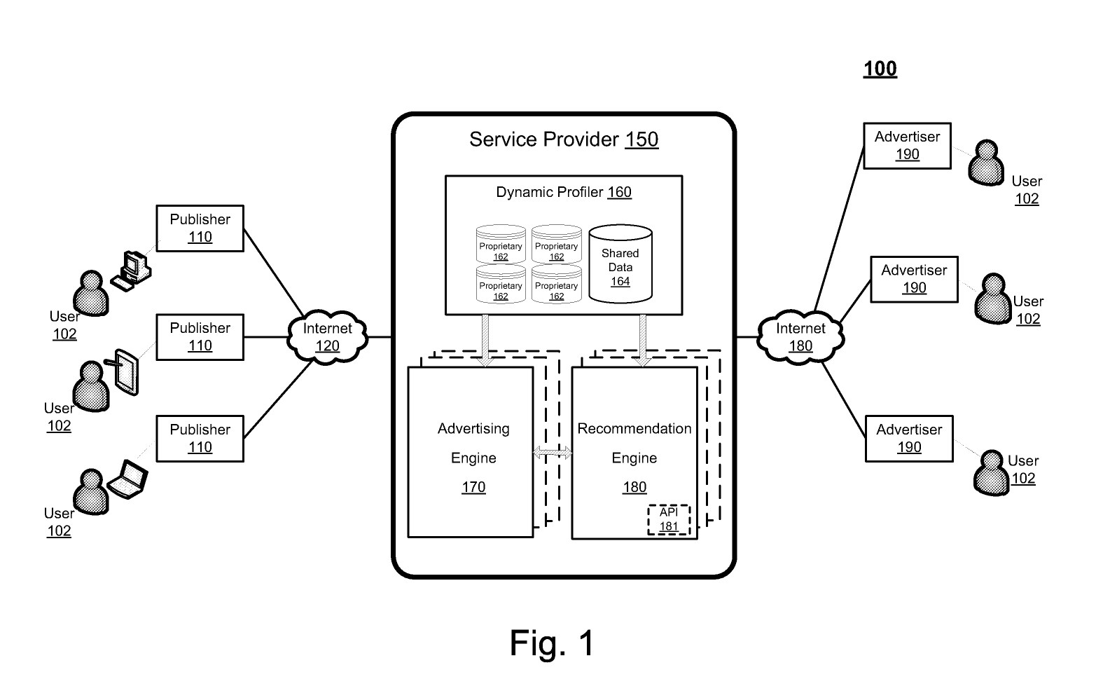

Referring to FIG. 1, one embodiment of a personalized advertising and recommendation system 100 includes a service provider 150 for providing advertising and recommendation of items to users 102, for example, over the internet. Very generally, the service provider 150 gathers comprehensive profiling data from sources across multiple domains (e.g., from users 102, publishers 110, and advertisers 190) to generate personalized marketing events that reflect users' preferences and shopping intentions. Some marketing events can be presented, for example, on an advertiser's web site in the form of recommendations, providing the advertiser's users (consumers) with recommendations of items selected from the advertiser's inventory. Other marketing events can be presented, for example, on a publisher's web site in the form of advertisements (ads), providing users (viewers) of the site with recommendations of items that are supplied by a third-party advertiser. In some implementations, the advertisers 190 may subscribe to services provided by the service provider 150, for example, to help place its product ads on a publisher's site or place product recommendations on its own site. In such cases, the advertisers 190 are also referred to as service subscribers.

In this document, the term “advertiser” is used broadly to include entities that promote products and services to consumers, including for example, product retailers and service providers in various industries. Entities that promote political, social, and/or cultural events to a general or targeted audience can also be viewed as advertisers.

The term “publisher” is used broadly to include entities capable of providing a platform for delivering messages of various types to their audiences. Examples of publishers include media groups such as newspapers and broadcast stations, search engines, web and email browsers, and other types of “publishing” entities (such as bloggers) with a message-delivery channel. A publisher (e.g., CNN) can host on its web site creatives supplied by advertisers (e.g., Overstock and Borders), for example, in the form of banner ads, sponsored links, landing pages, and etc. A publisher can also choose to host its own creatives (e.g., a promotional clip of CNN's 2008 presidential campaign coverage), in which case the publisher itself is also an advertiser.

In the embodiment of FIG. 1, to generate personalized product advertising and recommendation, the service provider 150 includes a dynamic profiler 160, which interacts with various publishers 110 and advertisers 190 to maintain a dynamic database of aggregated profiling information that can be used to locate or infer relevant items (products, services, events, etc.) to a particular user. Such profiling information includes, for example, demographics (such as age and gender), user preferences (such as tastes in music, movies, televisions, games, and merchants, brand loyalty), and a cumulative history of user activities (such as recent web searches, clicks, page views, purchases, and previous advertisement clicks and impressions).

In some implementations, the dynamic profiler 160 categorizes profiling information into two distinct types. The first type includes proprietary data 160, which is reserved for use only by authorized applications associated with specific advertisers 190. For example, Borders may have a privacy agreement with the service provider 150 that consumer transaction history occurred at Borders' online and local stores may only be used by Borders-approved applications (e.g., to generate marketing events on behalf of Borders or its business partners). The second type of profiling information includes shared data 164 that is accessible for use by entities across various domains, such as all publishers, advertisers, and their agents. Examples of shared data 164 include users' demographics, location, synthesized product and category preferences and interests, and other publicly available information.

Note that the dynamic profiler 160 does not necessarily have to store the database of information on its own hardware. For instance, in some implementations, the dynamic profiler 160 is primarily responsible for controlling the update of information whereas the actual data is distributed in some form to the advertisers' end. For example, some or all portions of proprietary data 162 associated with a particular advertiser may physically reside on the advertiser's own servers and be accessible by the dynamic profiler 160 over the internet 180. Also, some or all portions of the shared data 164 may be distributed to one or more advertisers 190 where the dynamic profiler 160 can remotely control the update of the information on a periodic basis.

In some examples, the dynamic profiler 160 also maintains for each user a globally unique identifier (GUID) that allows for efficient information gathering across a variety of sources. Each GUID can be associated with a list of cookies stored on the corresponding user's computer for authentication, session tracking, and other purposes. Information obtained via cookies placed by different entities (e.g., by different retailers) can be integrated into a single personalized user profile if they are recognized by the dynamic profiler 160 as being tied to the same user, or in other words, the same GUID, even though the user may have been given distinct customer IDs by different retailers. Such a user identification mechanism can assist with maintaining user-specific data on a large scale to improve advertising and recommendation performance.

Using information maintained by the dynamic profiler 160, the service provider 150 offers at least two types of services—an advertising service for generating personalized advertisements on a publisher's site, and a recommendation service for generating personalized recommendations on an advertiser's site. These two types of services may be implemented using techniques of similar mechanisms. In some examples, each type of service is provided by a separate service engine, for example, an advertising engine 170 and a recommendation engine 180 between which a communication channel is established for data sharing. The advertising engine or recommendation engine may include a single service component capable of providing the corresponding service to each and every subscriber, or alternatively, have multiple service components each configured for servicing a specific subgroup of subscribers. Various service components may be instrumented in either a centralized or a distributed manner. In some other examples, both advertising and recommendation services are provided by an integrated service engine (not shown) that have single or multiple service components centralized or distributed over multiple computers. In some further examples, the recommendation engine 180 includes an application programming interface (API) component 181 that provides message-based recommendation services upon request by the advertiser 190. Specifics about this API component 181 will be described later in this document.

For illustrative purposes and without limitation, the following sections of this document discuss some examples of the approaches that the service provider 150 can take to create personalized advertising and recommendation.

### 2 Advertising

Online advertising provides a useful platform for advertisers to deliver marketing messages to attract customers. Many publishers offer ad space on their web sites to let advertisers to display creatives (e.g., product recommendations and offers and promotions in the form of text, audio and/or video contents) to specific audiences. For ad space in high demand, the publisher may implement an auction mechanism by which individual ad spots are respectively awarded to the highest bidder. An advertiser may also have various types of profit-sharing agreements with publishers, for example, as to whether ad space is purchased by measures of cost per impression (CPI), cost per click (CPC), and cost per action (CPA). In any event, it is to the advertiser's advantage to present users with ads most relevant to the users' preferences and shopping interests.

The following section discusses two scenarios in which the service provider 150 can assist advertisers 190 with generating personalized ads.

### 2.1 Non-Auction or Post-Auction Scenario: Serve the Best Personalized Ad Given Advertiser

This first scenario assumes that an advertiser has already acquired an ad spot from a publisher (e.g., through auction or other purchase agreements). The service provider 150 is then asked to determine a personalized list of items to be advertised for that spot as well as to present these ads in a desirable form to users of the publisher's web site, thus helping the advertiser achieve its business objectives (e.g., to maximize conversion rate or the expected revenue from clicks on the ads). In this scenario, the service provider 150 is not necessarily involved in an ad auction/bidding process.

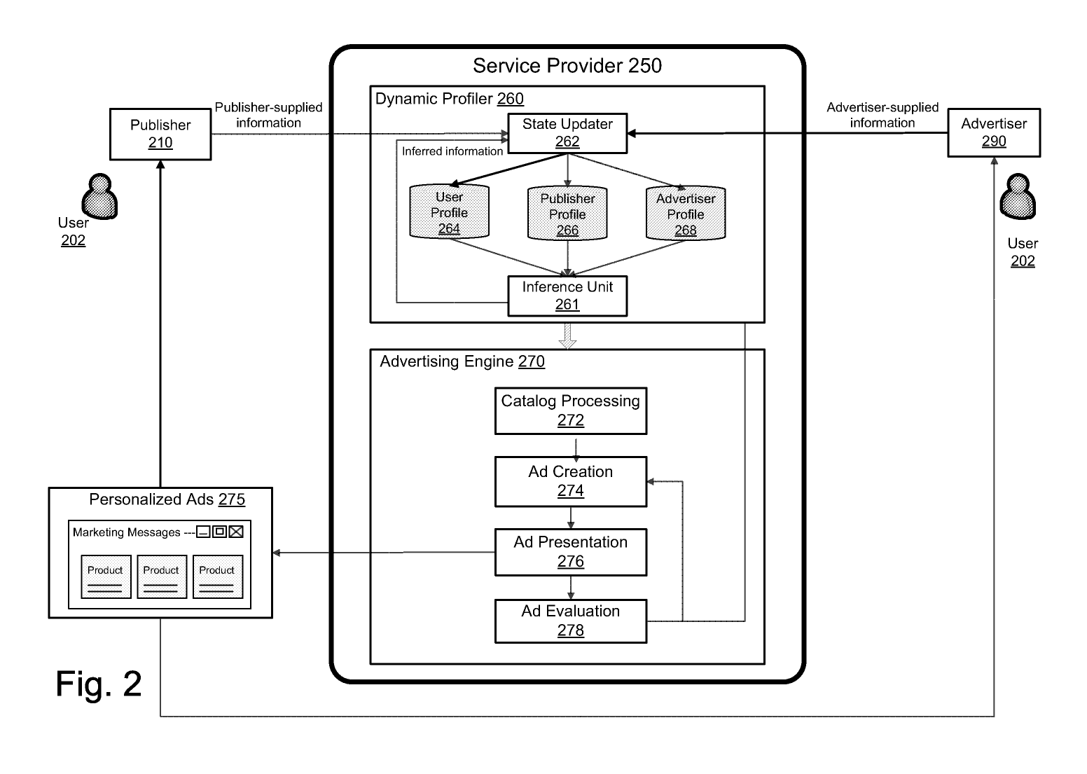

Referring to FIG. 2, one embodiment of the service provider 250 includes an advertising engine 270 configured for generating personalized ads based on data provided by a dynamic profiler 260. In this embodiment, the dynamic profiler 260 includes a state updater 260 that maintains a state of knowledge for items that can be advertised and for users to whom ads can be presented. More specifically, the state updater 260 frequently updates a user profile 264, a publisher profile 266, and an advertiser profile 268, using information elicited from various publishers 210, advertisers 290, and third-party suppliers (e.g., by purchases through certain information agencies). These profiles are not necessarily all distinct, with some potentially sharing common or cross-linked information. In some examples, the dynamic profiler 260 also includes an inference unit 261 that processes and/or combines the information provided by the publisher 210 and the advertiser 290, as well as data maintained in the three profiles 264, 266, and 268 to derive inferences that can be used to augment the state of knowledge. For instance, the inference unit 261 may use publisher-supplied information (such as 80% of users of this website like golf) to infer user preferences (such as the current user will probably like golf-related products), which is then provided to the state updater 262 to update the user profile 264.

In this embodiment, the user profile 260 includes a rich collection of user-related data, including for each individual user:
demographic information such as age, gender, the number of children in the household, household income, zip code, and cohort groups;
membership or visits of portals such as AOL, Yahoo!, CNN, and facebook;
customer identities at shopping services such as Amazon, eBay, and Borders;
action histories at advertisers' online and local stores, including purchasing history such as both finished and unfinished transactions, shopping carts, and returned purchases; exploratory activities; survey responses and product ratings;
visits to various interest areas such as sports, celebrities, news, and music, shopping;
recent web searches;
personal tastes in music, movies, television, games, and merchants; and
click rate and conversion history of previously encountered ads.

The publisher profile 266 includes, for each publisher:
contents of the web site at display such as cars, computers and apparel;
attributes of the available ad spot such as banner size and time limits, the maximum number of displayable items for a given spot, and other publisher-prescribed display rules;
average or individual users' viewing histories and habits on the publisher's web site;
user registration information such as user accounts at publisher's sites;
ad serving history and user responses such as click-through-rate;
publisher traffic reports; and
other relevant information of the web page such as time-of-day.

The advertiser profile 268 includes, for each advertiser:
an up-to-date inventory catalog;
attributes of items in the catalog, including product category and price;
user registration information such as online Borders accounts;
user's shopping carts, transaction history, and wish lists;
advertiser-specific ad generation rules, such as campaign templates and IDs, offers/message rules, category exclusions, and advertiser pixel tag; and
user response to previously served ads.

As previously described, some of the above profiling information is maintained as proprietary data accessible only via authorization, while others may be shared among publishers and advertisers without restrictions. Also, each user is assigned by the service provider 250 a globally unique identifier (GUID) that allows for easy integration of information received from different channels. In some examples, the state updater 262 periodically updates the three profiles to ensure a more accurate characterization of each entity and to capture new information and activities that occurred during the last action period. Some of these updates can be done on a daily or weekly basis, while others may be done nearly instantaneously (e.g., user response can be updated within seconds from his last ad click).

Based on the state of knowledge maintained by the dynamic profiler 260, the advertising engine 270 can dynamically create a group of individually targeted ads—each with its own combination of products, marketing message, and offer—and then traffic and manage those ads against a media buy. For illustrative purposes and without limitation, one procedure for use by the advertising engine 270 includes catalog processing 272, ad creation 274, ad presentation 276, and ad evaluation 278, each as described in detail below.

### 2.1.1 Catalog Processing

In some embodiments, to generate personalized ads for products and services, the advertising engine 270 processes product/service feeds provided by the advertiser 290 into a desired data scheme specific for a particular implementation. For example, product feeds may be provided by the advertiser 290 in a structured data file, with each data record containing, for example, attributes of a respective product such as name, description, list price, UPC code, and image URL. Different advertisers are likely to provide feeds of different data structures and with information at different levels of details. The advertising engine 270 retrieves and parses the product feeds from an advertiser to create a standardized product catalog that maps the received information to a particular scheme (e.g., a high-dimensional attribute space). In some examples, a common scheme can be adopted among a set of advertisers, with all products being attributized in essentially the same manner. In some other examples, each advertiser may define their own taxonomy for categorization of their products.

In one embodiment, the product catalog is divided into paths representing common pockets of interest. Take online store Overstock's product catalog for example. A path can be defined by a set of common attributes and may correspond to a single category of products (e.g., a “Bedding” path corresponding to the “Bedding” category), or a grouping of categories that share common attributes (e.g., a “Home” path representative of the grouping of the “Bedding” and “Furniture” categories). The results of such a processing can be useful, for example, for determining a particular user's shopping preferences and cohort groups if information about his viewing patterns and “path” history is available. Further discussions of this and other catalog processing techniques are provided in U.S. patent application Ser. No. 11/968,999 (Attorney Docket No. 30003-006001), titled “Music Recommendation Systems,” filed Jan. 3, 2008, the contents of which are incorporated herein by reference.

### 2.1.2 Ad Creation

Based on its knowledge of the user (such as shopping preferences and recent activities) as well as other information, the advertising engine 270 creates advertisements, and optionally along with individually targeted marketing messages and offers, to be presented to the user. Depending on the particular implementation, the advertising engine 270 can apply a variety of statistical modeling and analysis techniques to the available data in creating user-relevant advertisements.

In some embodiments, the advertising engine 270 forms a ranked list of items to be advertised to the user by modeling the attributes of the individual items obtained as a result of the catalog processing 272. In some examples, the advertising engine 270 may employ a model that associates a numeric variable (score) r_{i,n} to represent the cardinal preference of a user n for a particular item i. This variable r_{i,n} can be interpreted as the rating the user has previously given to item i (e.g., through a retailer's product survey), or the unknown rating the user would give to item i. In either case, the variable r_{i,n} is representative of a degree of relevancy of the item i to user n. Further discussions of this approach can be found in U.S. patent application Ser. No. 12/431,316 (Attorney Docket No. 30003-002003), titled “Statistical Personalized Recommendation System,” filed Apr. 28, 2009, the contents of which are incorporated herein by reference.

In some examples, the advertising engine 270 employs an optimization approach that seeks values of item attributes for improving (e.g., maximizing) an outcome of the advertising process. Such an outcome can be quantified, for example, by defining an objective function based on specific business goals. For example, the advertising engine 270 may be configured to select items that can maximize the click-through-rate (CTR), conversion rate, an expected revenue, average order size, or user interest of an advertisement. This optimization process is also conditioned on static and dynamic parameters as those determined from the state of knowledge, including for example, user to whom the ad will be displayed, web page on which the ad will be displayed, time-of-day the ad will be displayed, items in the catalog that are eligible or available to be shown.

Depending on the particular implementation, ad creation 274 can be carried out as user-driven, context-driven, cohort-driven, or a combination thereof.

In examples of user-driven processes, various types of information about the user, as aggregated by the service provider 250 from different channels through a learning mechanism, are used to identify items in line with the user's shopping intentions. More particularly, user activities that not just occurred with the present publisher and advertiser, but also with other publishers or advertisers, can in some cases provide valuable insight in making a good advertising decision. For example, advertising engine 270 may discover through the dynamic profiler 260 that the user has repeatedly searched for a particular product or product category (such as Apple laptop) in the past week through one or more search engines but has yet to make a purchase. If there are same or similar products in the current catalog that satisfy this user's search criterion, these products will likely be good candidates in an advertisement. As another example, a user who has exhibited certain behavioral preferences for music/movies (e.g., as revealed in his Netflix rental history) or is an active member of specific communities (e.g., Hannah Montana fan club) will likely be presented with products consistent with his preferences (e.g., recent album or movie release of Hannah Montana). As a further example, if a user has recently posted on his Facebook page asking friends for recommendations for a new tennis racket, such information can be flagged by the dynamic profiler 260 to alert the advertising engine 270 of this explicit shopping intention. As a fourth example, previously unfinished transactions, for examples, products in a user's Amazon shopping cart or wish list, can be displayed at CNN's web site to prompt the user to finish such transactions. Other examples or techniques of cumulating a user's product-level activities from multiple advertisers to drive the decision process of the advertising engine 170 are also possible.

In some implementations of user-driven processes, the selection of a certain item to be advertised to a user is directly associated with an observed user interest (either explicit or implicit) in that particular item. For example, a user's explicit interest in a particular book at Borders.com can be observed from his interactive history related to this book, for example, he has reviewed this book's detailed webpage, revisited this webpage multiple times during a day, bookmarked this page, added the book to his shopping cart or wish list, or searched for it at Google.com. A user's implicit interest in the book can be observed for example, based on events such as the user has posted a question about this book at a reader's club, or previously purchased a prequel of the book on Borders.com and given it a high rating. In some examples, the degree of user interest in the book can also be quantified using parametric analysis including for example, assigning different weights to different types of events (e.g., explicit vs. implicit). When the user is seen at CNN.com, the service provider 250 is able to provide item-specific advertising to the user that shows the exact book of user interest, in contrast to category-specific advertising that select items from a category of user interest.

In examples of context-driven processes, the advertising engine 270 examines the context in which the advertisements are presented, including for example, web pages, search result pages, mobile devices, and call centers. The advertising engine 270 also examines the content of the web pages, such as cars, computers, and apparel. The results of the examination, combined with data from the publisher profile 266, support advertising targeting by limiting the product selection pool to the relevant advertisements (e.g., auto advertisements may be more relevant on a web page about cars and trucks, compared to a web page about health and medicine). In some implementations, each product in the catalog is associated with keywords, for example, words and phrases derived from product description and/or categorization, or keywords provided by advertisers. When a publisher's web page is displayed, contents of the web page may be analyzed, for example, to determine the occurrence of keywords and therefore to infer the relevance of the corresponding products. For example, when a viewer is browsing Martha Stewart's online magazine's “Home and Garden” section that has matches for keyword “lamp,” lamp products in the catalog may be assigned higher weights than computer products and are more likely to be advertised to the user. In some examples, promotional or information advertisements may also be presented depending on the inferred user's state in the buying process (e.g., whether he is browsing products, adding products to the shopping cart, reviewing the shopping cart, or checking out). Another example of context-driven product selection is the identification of popular products in the particular advertiser's catalog among those users who have visited the particular publisher web page, site or domain as well as visited the advertiser site.

In examples of cohort-driven processes, cohort groups can be defined, for example, as groups of people who share certain common characteristics, such as demographic groups, geographical groups, political groups, academic groups, and cultural groups. The advertising engine 270 may analyze the characteristics of each group and form, for each individual cohort group, one or more sets of products that are representative to the common interests of the people in this group. Cohort parameters are then used to determine the preferred list of products to a user who belongs to a particular cohort group. In some examples, personalized modifications of the cohort parameters for individual users can also be computed using individual-specific history of activities and stated preferences.

Further discussions of some ad creation processes can be found in U.S. patent application Ser. No. 12/431,316 (Attorney Docket No. 30003-002003), titled “Statistical Personalized Recommendation System,” filed Apr. 28, 2009, and U.S. patent application Ser. No. 11/968,945 (Attorney Docket No. 30003-004001), titled “Personalized Shopping Systems,” filed Jan. 3, 2008. The contents of those two applications are incorporated herein by reference.

### 2.1.3 Ad Presentation

Once a list of items is selected for advertising, the advertising engine 270 determines the specific form in which these items will be presented. In some cases, marketing messages and promotional offers are also presented together with the selected items.

Very generally, the advertising engine 270 can be configured to display an advertisement 275 on a publisher's site as a text advertisement, a banner advertisement, a rich media advertisement, a marketing promotion, a coupon, a product recommendation, a sponsored link, or a combination thereof. Product information to be displayed may include, for example, product name, category, description, image URL, price, retailer name, reviews/ratings, and relevance scores. The specific form and content of the display can vary depending on the particular implementation, for example, in compliance with certain publisher- and/or advertiser-prescribed display rules and preferences. Some of the displays are created using ad templates that determine both the appearances and the interactive features (if any) of ads that belong to certain categories. For example, an advertiser may specify that items will be presented in live banners in the order of relevance and the contents of the banners are refreshed periodically (e.g., every 5 seconds) to provide the user with a rolling list of product recommendations. In each banner, an individual item is shown, for example, with three lines of product names, followed by retailer name, followed by price, and followed by product image. In addition, the advertiser may also specify that, for specific applications such as when advertising products with a high conversion expectation or with a high profit margin, a promotional offer (e.g., a 10% discount) will be generated together with the advertisement to increase the conversion likelihood.

In some examples, each advertisement 275 displays exactly one item at a time (e.g., the top-ranked item in a list of recommendable items). In some other examples, to increase click-through rate, multiple items are simultaneously displayed in one advertisement 275. In both cases, when a user clicks on (or mouses over) the advertisement 275 (or a particular item in the advertisement 275), a personalized dynamic landing page (e.g., as hosted by the advertiser's server) is generated to provide consumers with an extended array of personalized product recommendations consistent with the advertisement 275 being clicked.

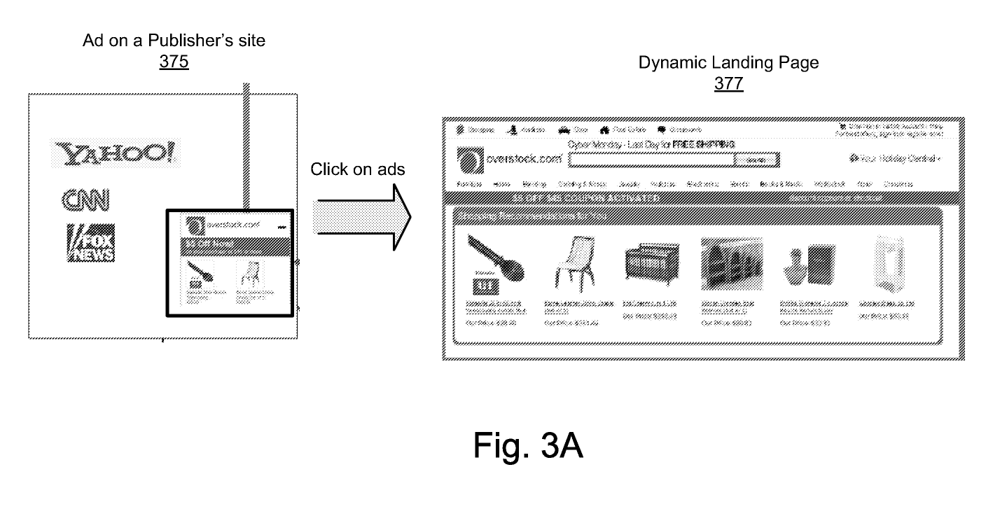

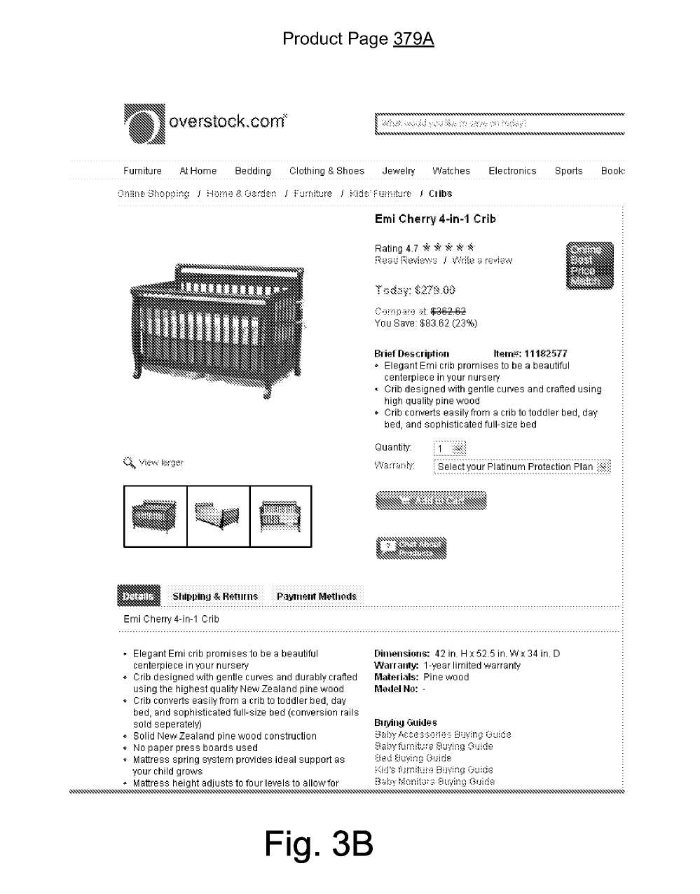

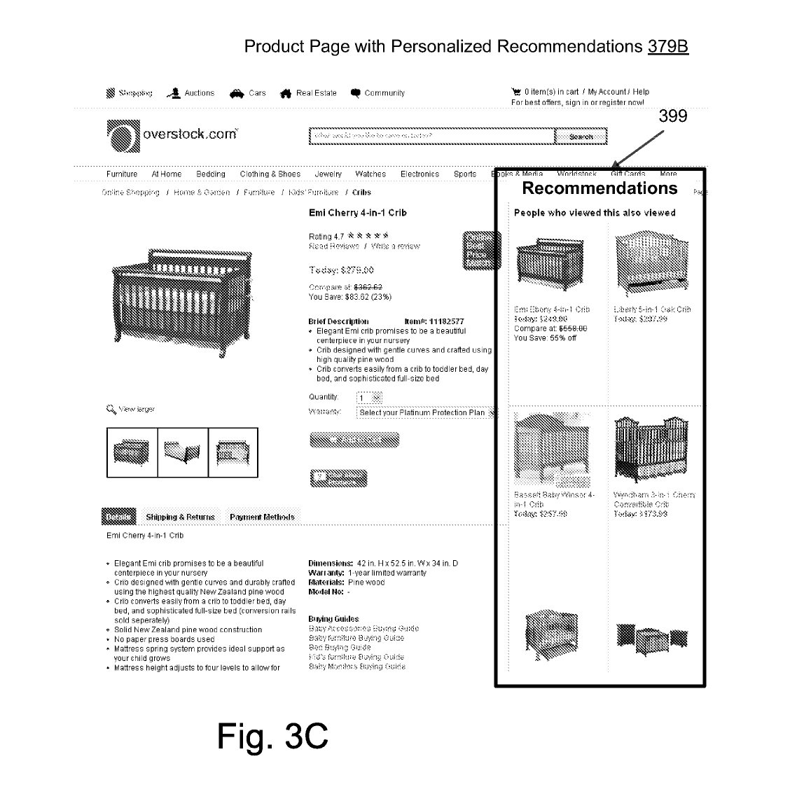

FIGS. 3A-3B show one example of a two-step ad presentation process during which a personalized dynamic landing page 377 is presented to the user. In this example, initially, when a user is viewing a publisher's site (e.g., CNN.com), an advertisement 375 for Overstock.com is visually displayed at a prescribed location on this website. This advertisement 375 includes two items that the advertising engine 270 has identified as relevant given this particular user's interests, together with a promotional offer from Overstock. Note that in general, the multiple items being displayed in one advertisement can belong to different categories of products carried by a single advertiser, or in some further examples, can come from different advertisers (e.g., a particular chair sold both at Overstock.com and Target.com).

When the user clicks on the advertisement 375, a personalized dynamic landing page 377 is provided in the user's browser to display an extended array of product recommendations for this user. This new list of items shown in the dynamic landing page 377 may extend beyond the list of items previously displayed in the advertisement 375. In some examples, the new list is determined by the service provider 250 based on the profiling information provided by the dynamic profiler 260 and may also depend on the particular item (if more than one are offered) on which the user clicked at the publisher's website. For instance, if the user clicks on the “Dining Chairs” item in the advertisement 375, chair- or furniture-related items may be promoted to the top of the list of candidate items to be shown in the landing page 377 to reflect the user's explicit interest in chairs.

In some embodiments, the dynamic landing page 377 is hosted by the advertiser's server, whereas the particular items to be shown on the landing page are determined by the service provider 250. In such cases, if products from multiple advertisers are shown in the advertisement 375, the user's browser loads the dynamic landing page from the one advertiser to which the user-clicked item belongs.

Once the user clicks on an item shown on the dynamic landing page 377, the product page 379 of the selected item is fetched from the corresponding advertiser to be presented to the user or the user is directed to the particular product page.

FIG. 3B shows one example of a product page 379A shown to the user, which displays essentially the same product information as one would normally obtain by directly accessing the product page through Overstock.com. Through this product page 379, the user can view detailed information about this product and proceed to checkout if desired.

In some examples, while the product page 379 is being fetched from the advertiser 290, the advertiser 290 sends a message to the service provider 350 to request a list of its own items suitable for recommendation to the user on this product page 379. In such cases, the service provider 250 uses its recommendation engine to process this request to create personalized recommendations on behalf of the advertiser.

FIG. 3C shown one example of a product page 379B on which personalized recommendations 399 are displayed together with the detailed product information.

### 2.1.4 Ad Evaluation

Once advertisements are generated and presented to the user, user feedback (including both action and inaction) is monitored, for example, to provide guidance on how to improve the effectiveness of the next advertisement. Tracking history such as real-time user activities and post-click and post-impression behaviors, is provided to the state updater 260 to further augment knowledge about user behaviors and preferences (e.g., what types of products are this user more likely to purchase through sponsored links, what forms of visual creatives are more effective on this particular user). Such information is also used by the ad creation process 274 to provide real-time recommendation sensitivity capable of attending user need within the next request. For example, if a user did not select a particular item in the present advertisement, this item will be removed from the next advertisement. This way, valuable advertising resources are utilized only on items of user interest. In examples where the advertising engine 270 implements a frequency-capping mechanism that limits the number of instances an item can be shown to a specific customer during a predetermined time period, ad tracking also helps determine whether such a limit has been reached. In some further examples, tracking data is collected for reporting purposes, for example, to provide the advertiser with a measure of the efficiency and quality of the advertisements generated by the advertising engine 270.

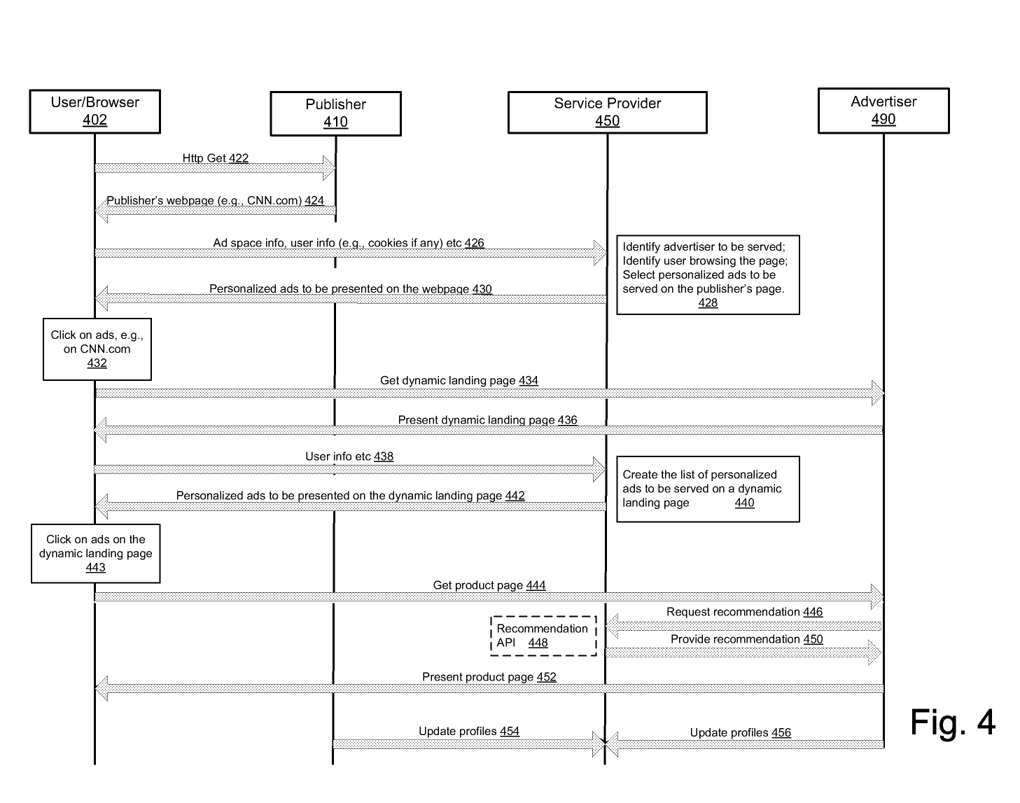

FIG. 4 further illustrates one procedure of a service provider 450 interacting with a publisher 410 (or a publisher server) and an advertiser 490 (or an advertiser server) for generating personalized advertisements according to the techniques described above. At step 422, a user's web browser 402 initiates an HTTP request to fetch a webpage (e.g., CNN.com) from the publisher 410. At step 424, the publisher 410 returns a response including markup for the requested webpage and an embedded ad script to be executed for the advertiser 490. At step 426, the browser 410 provides to the service provider 450 information relevant to the advertising process (such as ad space information, contextual parameters associated with the requested web page) as well as user information (e.g., as identified by detecting previously stored browser cookies or the IP address of the user's computer hosting the browser). At step 428, upon receipt of information from the browser 402, the service provider 450 makes a series of decisions, including, for example, which advertiser is to be served for this media buy (if it has not been predetermined) and which user profile is linked to the identity of the user currently viewing the webpage. Based on those decisions, the service provider 450 uses its advertising engine to determine a set of one or more items to be served as personalized ads on the publisher's web page. At step 430, specifications about the selected items, for example, product ID and textual descriptions in the form of markup language and product images in the form of URL, is provided to the browser 402 such that the personalized advertisements are visually displayed (e.g., as a banner advertisement) at a prescribed location on the publisher's web page.

At step 432, the user clicks on a particular item(s) in the advertisement shown on the publisher's web page. At step 434, the browser 402 sends a request to the corresponding advertiser 490 to fetch a dynamic landing page that is hosted by the advertiser 490 to provide the user with an extended array of personalized ads. At step 436, the advertiser 490 returns a response including markup for the dynamic landing page being requested. At step 438, the browser 402 communicates with the service provider 450 requesting a list of personalized ads (possibly including more than one items) to be served on the dynamic landing page. In response, the service provider 450 creates the list of personalized ads. This list may be the same as the list of personalized ads previously shown on the publisher's webpage, or may include additional items that extends beyond the original list. Also, information about each item may be provided in finer detail compared with what is previously displayed on the publisher's webpage. At step 442, specifications about these personalized ads are provided to the browser 402 to visually display the ads on the dynamic landing page.

At step 443, the user clicks on a selected product shown on the dynamic landing page. At step 444, the browser 402 initiates an HTTP request to fetch the product page (e.g., according to the URL associated with the selected product) hosted by the advertiser 490. Upon receipt of the HTTP request, at step 452, the advertiser 490 returns a response with markup for the requested product page to be displayed in the browser 402. In some applications, the returned product page exhibits the same amount of information (e.g., textual description, product images) and in the same form as one would typically obtain by directly accessing the product page from the advertiser's site. In some application, the returned product page also includes an additional recommendation feature that provides the user with a list of product recommendations (possibly different from the list shown on the dynamic landing page), for example, as determined by the service provider 450 using a recommendation API (at step 448). This recommendation feature will be described in further in a later section of this document.

At steps 454 and 456, the publisher 410 and the advertiser 490 send requests to the service provider 450 for updating profiling information based on user activities (e.g., click actions, transactions, viewing history) that occurred during this operation.

### 2.2 Advertising Network Scenario: Select the Most Relevant Advertiser and Ad Given the Sport

In this second scenario, the service provider 150 is configured to be an active participant of the online bidding/auction process to help advertisers optimize bids for advertising resources. The service provider 150 decides on whether to bid for the ad spot based on an understanding of one of more of the profiles: user profile, advertiser profiles across the service provider's network, and publisher profile. If a decision is made to bid, the service provider 150 selects the advertiser among eligible advertisers which maximizes business goals of the service provider 150 and satisfies the selected advertiser's goal. Then, the most relevant product(s) from the selected advertiser's catalog are served as recommendations in the ad.

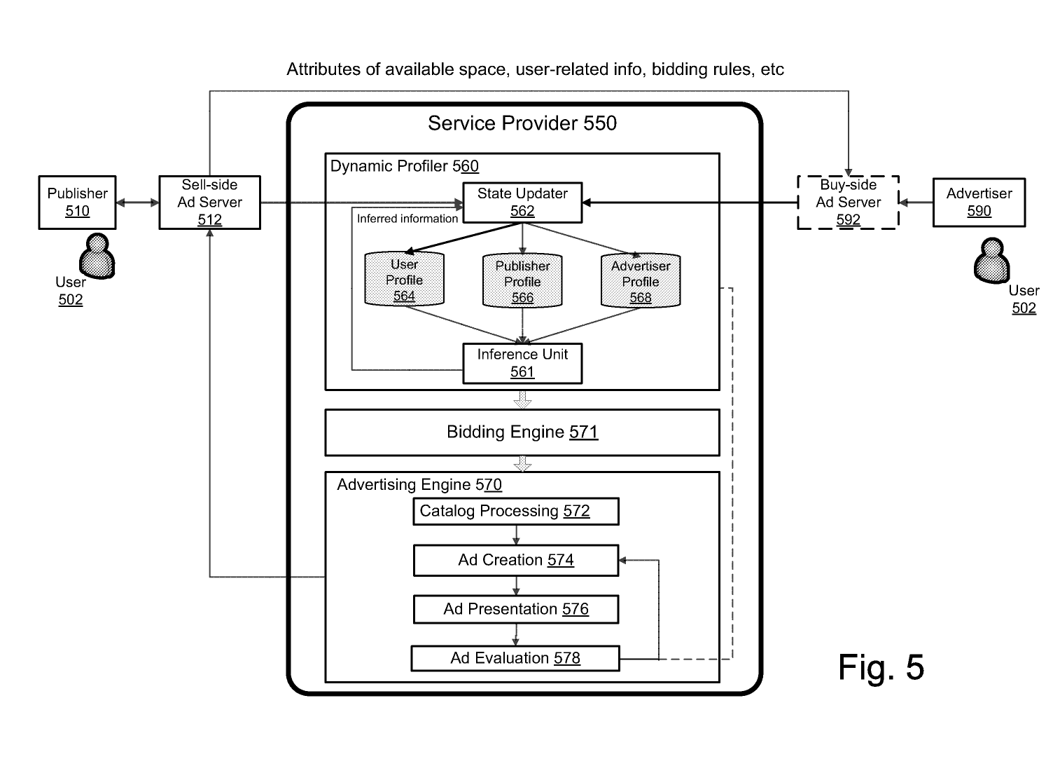

FIG. 5 shows one embodiment of a service provider 550 having a bidding engine 571 that works together with an advertiser 590 to bid for advertising resources offered by a publisher 510. In this embodiment, the publisher 510 employs a sell-side advertising server 512 that hosts auctions on behalf of the publisher 510. The advertiser 590 may employ a buy-side advertising server 592 that relies on information provided by the service provider 550 to place bids against other competitors for specific advertising resources released by the publisher 510. Alternatively, the advertiser 590 may appoint the service provider 550 to act as its buy-side advertising server 592 for bidding purposes. In the following examples, the service provider 550 is illustrated as being configured to function as the buy-side ad server 592 for advertiser Overstock.com.

Very generally, when the publisher 510 wishes to sell an ad space at a fixed or negotiable price, the sell-side ad server 512 sends a message on behalf of the publisher to a set of buy-side ad servers 592 (including the service provider 550 in this case), providing them with information of the available ad space (e.g., attributes such as banner size, time duration, keywords associated with the space), user-related information (e.g., user identity as detected by browser cookies or IP address), and/or specific bidding rules. Based on the received information, the service provider 550 can employ a statistical model to estimate an expected value of the ad space and accordingly determine the appropriate offer price. In situations where the service provider 550 identifies the user in its user profile 564, information about this user's past activities, shopping interests, and personal preferences allows the service provider 550 to develop a user-specific bidding strategy that can be more effective to other general bidding strategy (e.g., purely keyword-based).

For example, when Sports Illustrated is offering an ad space on its main page and the service provider 550 recognizes that the current viewer of the page is in the market for golf equipment, it may be willing to place a higher bid for advertising Overstock's golf-related products at this space, compared with other buy-side ad servers who has only limited contextual information provided by publisher (e.g., this ad space is served at a generally sports-related webpage).

Once the bidding engine 570 has successfully acquired an ad space, the advertising engine 570 subsequently determines the most relevant advertiser and associated list of user-relevant items to be advertized at this space, for example, using the techniques previously described with reference to FIG. 2.

### 3 Recommendation

While advertising provides an effective channel for advertisers to attract consumers through marketing messages delivered through a third-party portal, recommendations created directly on an advertiser's site offers another useful way for targeting consumers with relevant products and services as the user browses over its web site. In many situations, quality recommendations are proven to deliver a positive user experience and drive business uplift under various types of conditions. Also, quality recommendations help keep consumers engaged and make sure they find what they're looking for by recommending relevant alternatives as consumers browse content.

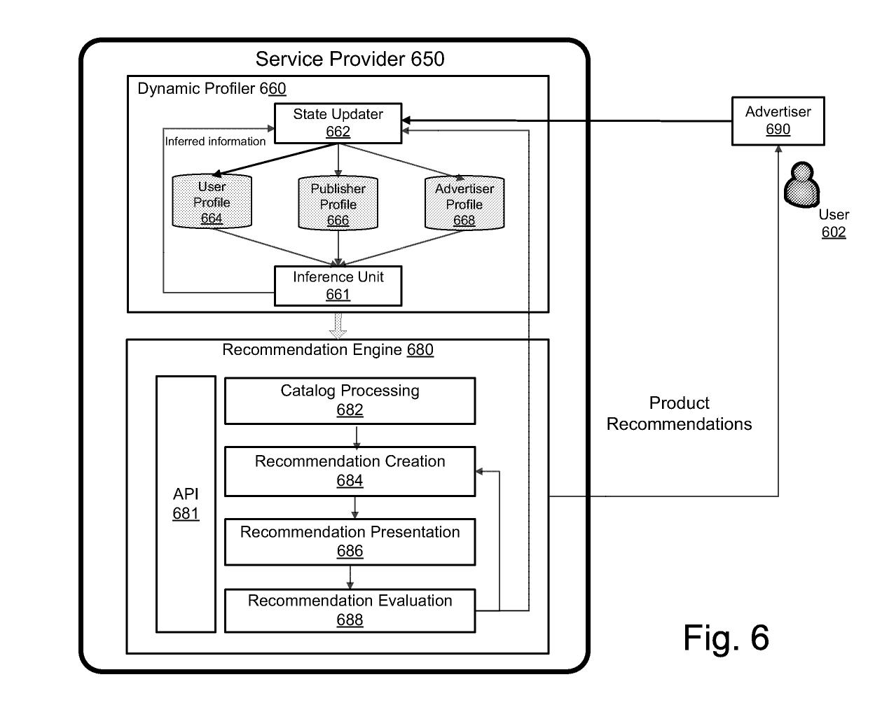

Referring now to FIG. 6, one embodiment of the service provider 650 includes a recommendation engine 680 for recommending to a present user 602 of an advertiser's application (e.g., online store) with a dynamic and personalized list of items relevant to this particular user's preferences. Generally, the list of items are selected from the advertiser's inventory and can be determined, for example, by analyzing the particular user's action history with the advertiser's application, the action history of other users, the application context (e.g., subscription-based application context, transaction-based application context, and/or advertisement-based application context) in which the particular user is interacting with the application.

In some examples, one procedure for use by the recommendation engine 680 includes catalog processing 682, recommendation creation 684, recommendation presentation 686, and recommendation evaluation 688. In some examples, each of those four components can be implemented using techniques similar to the ones described above with respect to the four components of the advertising engine 270 as shown with references to FIG. 2. In some other examples, the recommendation engine 680 also includes an API component 681 that provides an interface for providing message-based recommendation services to the advertiser 690. For instance, when the advertiser 690 detects that a particular user is viewing its website, it may send user identity to the service provider 650 and ask the service provider 650 to determine the list of suitable items to be recommended to this user. The API component 681 accepts this request and instructs other components of the recommendation engine 680 to obtain and analyze user data from the dynamic profiler 660 and to select a set of one or more items from the advertiser's inventory to be recommended to the user. Once the items are selected, specification of the items (e.g., data representing product ID, product description, and URLs of product images) is forwarded by the API component 681 to the advertiser 690. (Note that in some implementations, the advertising engine of the service provider may include a similar API component for handling advertising requests initiated by the publishers.)

In some other examples, the recommendation engine 680 can make use of additional or alternative techniques for finding personalized recommendations to users, either individually or in groups. For example, cohort analysis can be used to identify groups of users who exhibit similar behaviors over a set of interactions. More specifically, users' characteristics, their carefully elicited preferences, and a history of their ratings of the items are maintained in the user profile 664. Each individual user can then be assigned to one or more cohort groups, for which cohort-specific recommendations (e.g., in the form of editorial lists) can be generated based on cohort parameters. Personalized modification of cohort parameters for individual users are computed using the individual-specific action history and preferences to determine personalized picks from the editorial lists, enabling personalized editorial selections based on individual preferences.

As another example, in-session click analysis can be applied in conjunction with statistical analysis techniques to address situations regardless of whether user-related data (e.g., transaction information) is sufficient or sparse. For instance, statistical correlation of co-occurrences of product interaction (e.g., viewing, purchasing) within a session, with a user, and/or within the same basket can be used to find similarity between items and users and make recommendations of better quality.

As a third example, selective statistical techniques can be applied, for example, to remove items of high popularity from the list of items being recommended. This helps prevent recommending items that users are already likely to buy, or could easily find on their own.

As a fourth example, attribute correlation can be useful in recommending new, or rarely viewed items, for example, by computing correlations over item attributes, or over category/genre attributes, to infer the outcome of recommending new items based on knowledge of items of similar attributes.

As a fifth example, automated defaults can be used in cases when there is not enough data to make an informed decision using any of the techniques described above. In these cases, it is desirable to display items reasonable (e.g., the most popular items as automatically measured by top-sellers filters) than to waste the opportunity by showing nothing at all or content that is stale.

Further discussions of some of the above-mentioned techniques, for example, in the context of music recommendations, are provided in the U.S. patent application Ser. No. 11/968,999 (Attorney Docket No. 30003-006001), titled “Music Recommendation Systems,” filed Jan. 3, 2008, the contents of which are incorporated herein by reference.

Note that, although in the above description, the advertising engine and the recommendation engine are illustrated primarily as being configured for performing separate functions, in many situations, the two engines can be implemented as one integrated service engine that provide both types of services, or as two service engines that are implemented with a high degree of synergy. The techniques used by the recommendation engine in creating personalized lists of items for recommendation can be similarly used by the advertising engine, and vice versa. Approaches for maintaining the state of knowledge for use in both cases can also be similar. In examples where an advertiser is an existing subscriber of one type of service, the second type of service can be conveniently implemented by incorporating existing data structures and operation algorithms with minor modifications.

### 4 Other Features and Extensions

In addition to the general approaches and techniques described above, some specific features of the service provider 150 are described below.

### 4.1 User Retargeting

Another area of application relates to user re-targeting or re-tagging, which provides tools for discovering the identity of an existing or past user by matching the present information about the user against data in the cross-advertiser, cross-publisher user profile maintained by the service provider 150.

One example relates to the above-mentioned adverting contexts, in which the service provider 150 keeps track of a user's online behaviors that occurred at various portals by associating multiple online identities (e.g., different customer IDs at various stores) with a single GUID in the user profile. If someone buys a book from Borders, leaves this site, and later logs in at a new site, say Facebook, the service provider 150 can post a Border's ad with specific book recommendations on this user's Facebook homepage, prompting the user to re-visit Borders in the near future.

Another example relates to retagging users when the linkage between user identity and the service provider's user profile is missing or compromised. For instance, the service provider 150 may place a cookie on a user's browser for associating this user's computer with a unique GUID in the user profile. If the user deletes this cookie from his computer and is assigned a new GUID after appearing on web sites affiliated with the service provider 150, the service provider may discover that the two GUIDs in fact correspond to the same user, for example, by recognizing that the user's facebook account information or his computer's IP addresses are identical in these two cases. Accordingly, the service provider 150 can associate the new GUID with the old GUID and combine the old and new data records into a consolidated user profile.

### 4.2 Performance Reports

In some examples, the service provider 150 generates detailed performance reports to its service subscribers (e.g., advertisers) with information of various types, providing a measure of the effectiveness of advertising and recommendation efforts. Depending on the particular interests of individual advertiser, the service reports can include one or more of the flowing:
Traffic reports, which detail the number of page views (e.g., recommendation sets served), unique users, sessions and performance by application context on a regular basis such as daily, weekly, or monthly. Here, application context refers to a specific placement of a set of recommendations, such as cross-sell recommendations on a product detail page or next-sells on an order confirmation.
Click-through reports, which provide daily, weekly, or monthly detail on the number of clicks on recommendations/advertisements and click-through rates by application context.
Click revenue reports, which detail the amount of revenue earned and conversion rates generated through recommendations/advertisements by application context.

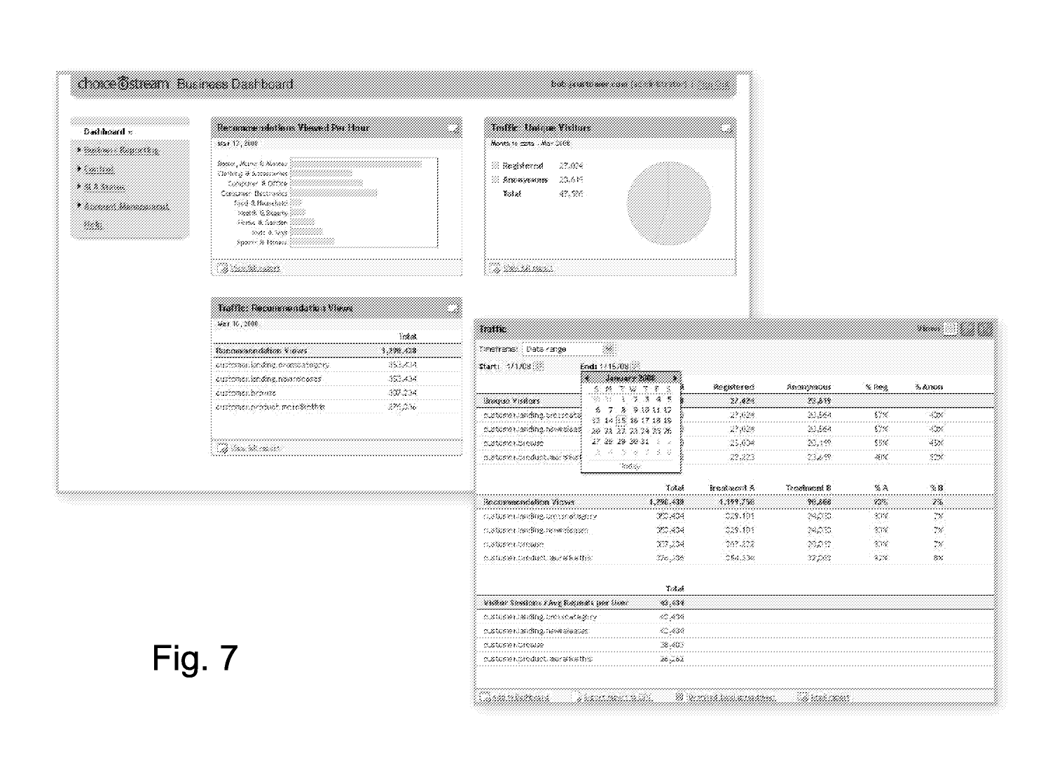

FIG. 7 shows examples of reports that the service provider 150 may generate for its service subscriber.

### 4.3 Editorial Tools

In some examples, the service provider 150 also offers interactive tools that allow the advertiser to influence the content or items being recommended or advertised. Examples of the various types of marketing and editorial controls include:
Blacklists, which provide lists of items that should not be recommended or advertised. This control can be used, for example, to ensure that recommendations do not display products or content that is being promoted elsewhere on a page, and to make sure that specific catalog items are not displayed in inappropriate contexts.
Boosts, which make individual or groups of products more likely to be recommended without necessarily forcing them to be recommended all of the time. This control has several uses, including, increasing exposure of slow-moving inventory without promoting it to everyone, promoting all products of a particular brand(s) in support of a specific marketing program, and making all products with a specific attribute more visible around a particular holiday or season.
Filtering rules, which restrict recommendations (e.g., via inclusion or exclusion) to a subset of the total catalog by setting rules that key off of an attribute of the items in the catalog (e.g., price, size, genre). This tool can be used, for example, to highlight new catalog additions, or to restrict recommendations to products at or above, particular inventory or margin levels.
Business goal optimization, which allows the advertiser to define a specific business goal such as average order size, total revenue, gross margin, or click-through rate, and to optimize recommendations/advertisements according to the goal. As the goal changes, the service provider 150 is able to adapt quickly to reflect the new priorities.

### 4.4 Data Integration and Updates

In some examples, the service provider 150 also employs tools for capturing user activities and catalog information in real time. Changes in user preferences, user activities (e.g., transactions, clicks, page views), and other profiling parameters causes the service provider 150 to update its state of knowledge to drive recommendation or advertising decisions to reflect those changes. The service provider 150 also keeps track of the “freshness” of its data, for example, by creating a respective time stamp corresponding to the time at which each individual piece of information is collected. Out-of-date information can be gradually discounted (e.g., using an aging factor) so that personalized recommendations are more oriented toward a user's recent activities.

In some examples, the service provider 150 also provides tools for incorporating offline data (e.g., transaction data from local stores) into its state of knowledge to improve users' online experience.

### 4.5 Multi-Channel Integration

Although in this description, personalized advertising and recommendation are discussed primarily in the context of internet-based activities, such services can be readily extended to other types of marketing platforms that an advertiser uses to reach its customers. For example, as mobile devices mature and TV becomes more interactive, recommendations and advertisements can appear on those platforms too, as well as in-store kiosks and call centers. Data collected on one platform can be use to inform the recommendations delivered on another for providing user with a coherent, integrated customer experience across all touchpoints (e.g., online store, direct mail, local stores, mobile phones, televisions, emails, call centers, kiosks).

Referring back to FIG. 1, the user 102 can interact with the publisher 110 and the advertiser 190 via a computing device, which can be implemented as a mobile device such as a cellular telephone, a wireless PDA, a handheld gaming device, a wireless laptop computer, or alternatively be implemented as a stationary device such as a desktop computer, set-top box for a television, or other fixed devices, with which wired and/or wireless communication can be enabled. The computing device includes a graphical user interface and/or a Web browser through which the user 102 can provide input to, or otherwise interact with, the publisher's applications.

In some embodiments, some of the services described above can be implemented as hosted services, for example, with one recommendation server dedicated for each advertiser without necessarily requiring complex data feeds or programming. Alternatively, the services are provided in the form of shared services, for example, with the resources of one recommendation server being shared among multiple advertisers.

It is to be understood that the foregoing description is intended to illustrate and not to limit the scope of the invention, which is defined by the scope of the appended claims. Other embodiments are within the scope of the following claims.

What is claimed is:

1. A computer-implemented method for recommending items to users comprising:
maintaining, by a service provider, a database of user-related information including storing a plurality of user profiles, each user profile including at least a history of user activities associated with a first entity that has a relationship with an inventory of recommendable items, wherein the history of user activities includes data representing events indicative of user's item-specific interest in each of a subset of one or more recommendable items, and the first entity is different from the service provider;
obtaining information about an identity of a user interacting with a second entity different from the first entity and different from the service provider;
associating the identity of the user interacting with the second entity with a corresponding user profile in the database;
selecting a first set of one or more items from the inventory of recommendable items for presentation to the user based at least on an analysis of the history of user activities associated with the first entity, including:
selecting at least one item from the subset of recommendable items based on data representing events indicative of user's item-specific interest; and
forming a specification of the selected first set of one or more items for presentation to the user during the user's interaction with the second entity.

2. The computer-implemented method of claim 1, wherein selecting at least one item of user interest includes:
computing, for each item in the subset of recommendable items, a degree of user interest based at least on data representing events indicative of user's item-specific interest.

3. The computer-implemented method of claim 1 wherein selecting the set of one or more items includes:
computing, for each item in the inventory, a degree of user relevance based on the analysis of the history of user activities associated with the first entity.

4. The computer-implemented method of claim 3 wherein the degree of user relevance is further computed based on an analysis of a context of the user's interaction with the second entity.

5. The computer-implemented method of claim 1 further comprising:
in response to a user reaction to the presentation of the selected first set of one or more items, selecting a second set of one or more items from the inventory of recommendable items for subsequent presentation to the user based on at least on the corresponding user profile.

6. The computer-implemented method of claim 5 wherein the second set of one or more items is at least partially different from the set of one or more items selected based at least on an analysis of the history of user activities associated with the first entity.

7. The computer-implemented method of claim 5 further comprising:
forming a specification of the second set of one or more items for subsequent presentation to the user.

8. The computer-implemented method of claim 7 wherein the subsequent presentation of the second set of one or more items is provided in the form of a dynamic landing page.

9. The computer-implemented method of claim 7 further comprising:
upon user selection of an item from the second set of one or more items to the user, determining a third set of one or more items to be recommended to the user during a presentation of the selected item to the user.

10. The computer-implemented method of claim 9 further comprising:
forming a specification of the third set of one or more items to be recommended to the user; and
providing the formed specification of the third set of one or more items to the first entity.

11. The computer-implemented method of claim 10 further comprising:
updating the corresponding user profile according to user activities associated with the presentations of the first, the second, and the third set of one or more items.

12. The computer-implemented method of claim 1 wherein the first entity has a business relationship with the inventory of recommendable items.

13. The computer-implemented method of claim 6 wherein the first entity includes a supplier of the inventory of recommendable items.

14. The computer-implemented method of claim 1 wherein the first entity has a non-business relationship with the inventory of recommendable items.

15. The computer-implemented method of claim 1 wherein the events indicative of user's item-specific interest in a recommendable item includes user interaction with the item.

16. The computer-implemented method of claim 1, wherein obtaining information about an identity of a user interacting with the second entity includes obtaining information about the identity of the user from the second entity.

17. The computer-implemented method of claim 1, wherein the first entity includes an advertiser.

18. The computer-implemented method of claim 1, wherein the first entity includes a plurality of advertisers each having a relationship with a respective inventory of recommendable items, and maintaining the database of user-related information includes updating each user profile according to user activities associated with one or more of the plurality of advertisers.

19. The computer-implemented method of claim 1, wherein the second entity includes a publisher.

20. The computer-implemented method of claim 1, wherein the user's item-specific interest in each of a subset of one or more recommendable items includes the user's explicit interest, implicit interest, or a combination of both.

21. The computer-implemented method of claim 1, further comprising presenting the first set of one or more items to the user during the user's interaction with the second entity.

22. The computer-implemented method of claim 1, wherein the specification of the selected first set of one or more items includes data representing an identification of the selected items in the inventory.

23. The computer-implemented method of claim 22, wherein the specification of the selected first set of one or more items further includes data representing a URL of an image associated with the selected item.

24. A system for servicing clients comprising:
a data manager for managing a database of user-related information, the database including a plurality of user profiles, each user profile including at least a history of user activities associated with one or more of a set of clients each client having a relationship with a corresponding inventory of recommendable items, wherein the history of user activities includes data representing events indicative of user's item-specific interest; and
a server for recommending items to users based on the information in the database, the server including:
an interface for accepting, from a data network, a service request associated with a client for recommending items to a user of said client, the service request including data representing an identity of the user;
a service engine coupled to the interface for selecting a set of one or more items from the inventory of recommendable items corresponding to said client to be recommended to the user, the service engine being configured for:
associating the user with a corresponding user profile in the database according to the data representing the identity of the user;
selecting the set of one or more items to be recommended to the user based at least on an analysis of data representing events indicative of the user's item-specific interest;
forming a specification of the selected set of one or more items for presentation to the user during the user's interaction with the second entity; and
instructing the interface to send, via the data network, a response to said client forwarding the specification of the selected set of one or more items.

25. The system of claim 24, wherein the service request is initiated by said client.

26. The system of claim 25, wherein said client includes an advertiser.

27. The system of claim 24, wherein the service request is initiated by an entity hosting an advertising resource designated for said client.

28. The system of claim 27, wherein the entity hosting the advertising resource includes a publisher.

29. The system of claim 24, wherein the database includes public data commonly accessible by each of the set of clients.

30. The system of claim 24, wherein the database includes a collection of one or more sets of proprietary data each set being accessibly only by a corresponding authorized client.

31. The system of claim 24, wherein the service engine is further configured for selecting the set of one or more items based on the user's history of activities that occurred with a second client different from said client with which the service request is associated.

32. The system of claim 24, wherein the data manager is further configured for updating the plurality of user profiles using data provided by one or more of the clients over the data network.
